(19) United States
(12) Patent Application Publication
(10) Pub. No.: US 2012/0027985 A1
(43) Pub. Date: Feb. 2, 2012

(54) ANISOTROPIC REINFORCING METAL PLATE

(76) Inventors: Toshiro Suzuki, Kawasaki-shi (JP); Eiichiroh Saeki, Tokyo (JP); Daiji Nakano, Tokyo (JP)

(21) Appl. No.: 13/138,841

(22) PCT Filed: Mar. 29, 2010
(86) PCT No.: PCT/JP2010/002239

§ 371 Date: Oct. 5, 2011

(30) Foreign Application Priority Data
Apr. 7, 2009 (JP) 2009-093111

(51) Int. Cl. B32B 3/14; B32B 3/10

(52) U.S. Cl. 428/77; 428/138

(57) ABSTRACT

Provided is an anisotropic reinforcing metal plate having a high shear capacity in a predetermined direction. The anisotropic reinforcing metal plate is provided with a rectangular metal plate, a first frame member disposed along a first direction and a second direction along an external edge of the metal plate and fixed to the metal plate in such a manner that a surface along the width direction opposes the metal plate, and reinforcing members disposed along the first direction or the second direction.

### TECHNICAL FIELD

The present invention relates to an anisotropic reinforcing metal plate (shear panel) resistant to horizontal external forces such as seismic and wind forces which act on buildings and other structures.

The application concerned is to claim the right of priority to Japanese Patent Application No. 2009-093111 filed on Apr. 7, 2009, with the content cited herewith.

### BACKGROUND ART

Upon action of horizontal external forces such as seismic and wind forces, a shear panel constituted with a rectangular metal plate and others placed at buildings and other structures is subjected to shear force. The rectangular metal plate subjected to shear force causes a buckling phenomenon, thus making it difficult to secure a large shear capacity. Therefore, in general, reinforcing materials (stiffeners) are arranged in a lattice pattern to secure shear capacity. Although shear yield capacity is secured, it is difficult to maintain this capacity with deformation after shear yielding advancing, and also maintain stable hysteretic characteristics (restoring force characteristics) in relation to loads repeated by positive-negative alternation. Therefore, it is necessary to decrease the width-to-thickness ratio and also arrange many stiffeners in a lattice pattern.

In order for a metal plate to be made relatively higher in shear buckling loads than yield shear loads, a method is available in which a material having an extremely low degree of stress at a yield point (for example, low yield-point steel) in relation to shear strength required in engineering design is used to increase the thickness of the metal plate, thereby avoiding early stage shear buckling to increase the plastic deformation capacity after yield. In this case, the metal plate can be used as a damping wall. Further, in order to keep the strength capacity of the metal plate on which shear force acts, there have been various proposals such as a wall plate into which a viscoelastic material is assembled and a devised method for joining wall plate and a building element.

### PRIOR ART DOCUMENT

### Patent Document

Patent Document 1: Japanese Published Unexamined Patent Application No. 2002-067217
Patent Document 2: Japanese Published Unexamined Patent Application No. 2003-172040
Patent Document 3: Japanese Published Unexamined Patent Application No. 2004-270208
Patent Document 4: Japanese Published Unexamined Patent Application No. 2005-042423
Patent Document 5: Japanese Published Unexamined Patent Application No. 2008-008364

### Non-Patent Document

Non-patent Document 1: Hiromi Kihara and Shingo Torii, “Design of seismic damping structure by using extremely low yield-point steel wall plates”, The Kenchiku Gijutsu, November, 1998

### SUMMARY OF THE INVENTION

### Problem to be Solved by the Invention

According to a conventional reinforcing method, in general, lattice-patterned stiffeners are joined by fillet welding. Further, since it is difficult to weld a thin metal plate, generally used is a metal plate with a thickness of 6 mm or more. Therefore, a shear panel in low rigidity and low strength capacity cannot be produced but in great rigidity and great strength capacity can only be produced. The present invention has been made in view of the above problem, an object of which is to provide an anisotropic reinforcing metal plate which is improved in shear capacity.

### Means for Solving the Problem

In order to solve the above problem, the anisotropic reinforcing metal plate of the present invention is an anisotropic reinforcing metal plate having a high shear capacity in a predetermined direction. Also, the anisotropic reinforcing metal plate is provided with a rectangular metal plate, a first frame member disposed along a first direction and a second direction along an external edge of the metal plate and fixed to the metal plate in such a manner that a surface of the first frame member along the width direction opposes the metal plate, and reinforcing members disposed along the first direction or the second direction.

In the above-described anisotropic reinforcing metal plate, the reinforcing members may be fixed to the metal plate so that a surface along the width direction opposes the metal plate.

The anisotropic reinforcing metal plate may have a clearance between the first frame member and the reinforcing member.

The anisotropic reinforcing metal plate may be that in which the metal plate is longer in the first direction than in the second direction and which is further provided with a second frame member disposed along the second direction at the center portion of the metal plate in the first direction with the reinforcing member disposed between the first frame member and the second frame member disposed along the second direction.

The anisotropic reinforcing metal plate may be further provided with an unbonded material between the metal plate and the reinforcing member.

### Effect of the Invention

The present invention is able to improve the shear capacity of the anisotropic reinforcing metal plate.

### BRIEF DESCRIPTION OF THE DRAWINGS

FIGS. 1(a)-(c) are drawings which show an anisotropic reinforcing metal plate of a first embodiment, (a) is a front elevational view, (b) is a cross sectional view and (c) is a longitudinal sectional view.

FIG. 2 is a stress strain diagram of a metal plate of the first embodiment.

FIGS. 3(a)-(c) are stress contour views of the metal plate of the first embodiment.

FIGS. 4(a)-(c) are drawings which show an anisotropic reinforcing metal plate of a second embodiment, (a) is a front elevational view, (b) is a cross sectional view and (c) is a longitudinal sectional view.

FIGS. 5(a)-(c) are drawings which show an anisotropic reinforcing metal plate of a third embodiment, (a) is a front elevational view, (b) is a cross sectional view, and (c) is a longitudinal sectional view.

FIG. 6 is a stress strain diagram of the metal plates of the second embodiment and the third embodiment.

FIG. 7 is a sectional view of an anisotropic reinforcing metal plate which has unbonded materials.

### MODE(S) FOR CARRYING OUT THE INVENTION

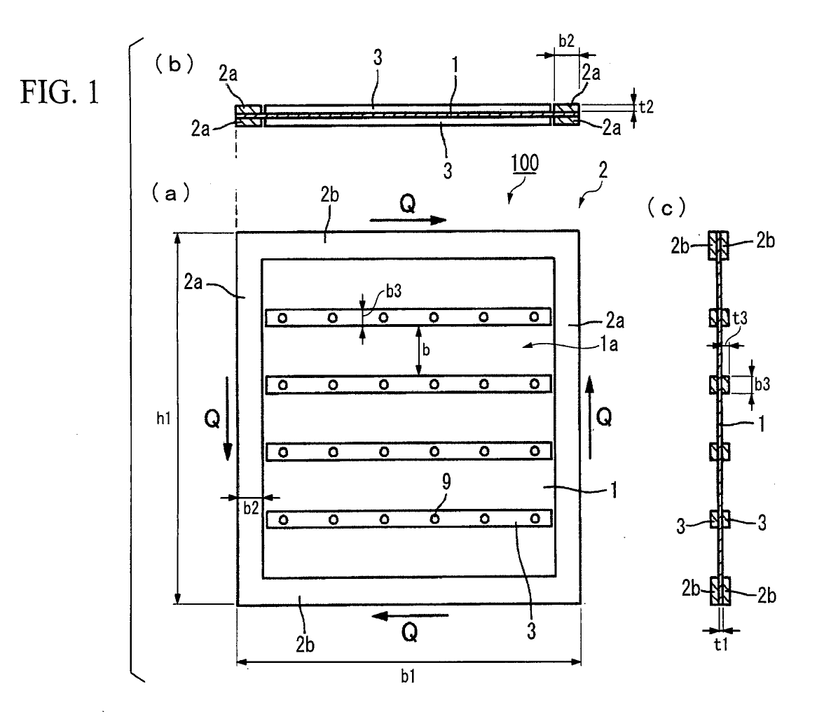

Hereinafter, an explanation will be made for the first embodiment of the present invention by referring to FIGS. 1 to 3.

The anisotropic reinforcing metal plate of the present embodiment has a high shear capacity in a predetermined direction and stably maintains yield shear capacity up to the large deformation range. That is, the anisotropic reinforcing metal plate of the present embodiment is provided with a reinforcing structure capable of increasing shear buckling loads of a rectangular metal plate on which shear force mainly acts, thereby securing shear yielding loads necessary in engineering design.

FIGS. 1(a)-(c) are drawings which show the anisotropic reinforcing metal plate of the first embodiment, (a) is a front elevational view, (b) is a cross sectional view and (c) is a longitudinal sectional view.

As shown in FIGS. 1(a)-(c), an anisotropic reinforcing metal plate 100 is substantially constituted with a rectangular metal plate 1, a picture frame-like frame portion (peripheral frame member) 2 and band plate-like reinforcing members 3.

The metal plate 1, which is made of metal such as steel and lightweight metal, is a square metal plate with a width b1 of about 900 mm, a height h1 of about 900 mm and a thickness t1 of about 3.2 mm. In the present embodiment, the metal plate 1 is made of soft steel SS 400 with the degree of stress at yield point of σy=30 kN/cm², Young's modulus of E=20 and 500 kN/cm².

The frame portion 2 is installed in a picture-frame manner with a pair of first frame members 2a disposed along a first direction along an external edge of the metal plate 1 and a pair of first frame members 2b disposed along a second direction along an external edge of the metal plate 1. The frame portion 2 is increased in in-plane bending rigidity of the metal plate 1 so as to repel oblique principal stress acting on the metal plate 1 after shear yielding. Further, the frame portion 2 has cross sectional area which shows elasticity at a point in time when the metal plate 1 undergoes shear yielding and is designed so as to prevent a reduction in shear capacity of the metal plate 1 after shear yielding and also maintain the shear capacity.

Each of first frame members 2a, 2b is a band-like plate with a width b2 of about 65 mm, for example. Each of the first frame members 2a, 2b has a rectangular cross section greater in the width b2 than a thickness t2. Each of the first frame members 2a, 2b is disposed along an external edge of the metal plate 1 and disposed in such a manner that a surface in a direction of the width b2 (wider surface) opposes the metal plate 1. In general, in a cross section having a long side direction and a short side direction such as a rectangular cross section, the long side direction represents the width, while the short side direction represents the thickness. Therefore, in the present embodiment, a surface along the width direction is a surface along the long side direction of the cross section in the case of a cross section having the short side direction and the long side direction.

The first frame members 2a, 2b are joined to the metal plate 1, for example, in a spot pattern, a linear pattern or an areal pattern and fixed to the metal plate 1. The first frame members 2a, 2b are joined to the metal plate 1, for example, by welding or using an adhesive agent. The first frame members 2a, 2b are disposed on both surfaces of the metal plate 1, and external edge portions of the metal plate 1 are held between a pair of first frame members 2a and a pair of first frame members 2b.

The reinforcing member 3 is a band-like plate with a width b3 of about 50 mm and a thickness t3 of about 12 mm. Each of the reinforcing members 3 is disposed along one of the first frame members 2a, 2b disposed in a direction perpendicularly intersecting with each other. In the present embodiment, each of the reinforcing members 3 is disposed substantially parallel to the first frame member 2b along the first frame member 2b. That is, each of the reinforcing members 3 is disposed along the second direction along an external edge of the metal plate 1. Further, where the metal plate 1 is formed in a square, each of the reinforcing members 3 may be disposed along the first direction along an external edge of the metal plate 1.

Each of the reinforcing members 3 is formed a rectangular cross section at which the width b3 is greater than the thickness t3 and disposed on both surfaces of the metal plate 1 in such a manner that a surface in a direction of the width b3 opposes the metal plate 1.

The reinforcing member 3 is joined to the metal plate 1, for example, by fastening a pair of reinforcing members 3 with fasteners 9 such as bolts and nuts via the metal plate 1 and thereby fixed to the metal plate 1. Each of the reinforcing members 3 is fixed to the metal plate 1 by the fasteners 9 disposed approximately at equal intervals in a direction of the width b1 of the metal plate 1.

The both end portions of the reinforcing member 3 are spaced away from the frame portion 2 with respect to one another to form a clearance therebetween. It is not always necessary to keep a space between the both end portions of the reinforcing member 3 and the frame portion 2, and they may be in contact with each other. In this case, the reinforcing member 3 and the frame portion 2 are not joined to each other.

Two or more of the reinforcing members 3 are disposed in an alignment substantially parallel at a region inside the frame portion 2 of the metal plate 1. FIGS. 1(a)-(c) show a case where four of the reinforcing members 3 are used. However, a greater number of the reinforcing members 3 are actually used. The number of the reinforcing members 3 is determined, for example, according to a width-to-thickness ratio b/t1 obtained by dividing the width b of a rectangular region 1a in the short side direction on the metal plate 1 sectioned by the first frame members 2a, 2b and the reinforcing members 3 by the thickness t1 of the metal Plate 1.

Here, in order to improve yield loads as shear capacity of the metal plate 1, it is desirable that the width-to-thickness ratio b/t1 be 100 or less where the metal plate 1 is made of steel. Further, where the metal plate 1 is made of lightweight metal, it is desirable that the width-to-thickness ratio b/t1 be 60 or less.

Further, in order to stabilize hysteretic characteristics of the metal plate 1 after shear yielding, it is desirable that the width-to-thickness ratio b/t1 be 50 or less where the metal plate 1 is made of steel. Still further, where the metal plate 1 is made of lightweight metal, it is desirable that the width-to-thickness ratio b/t1 be 30 or less.

Due to a difference in Young's modulus between a soft steel material and a lightweight metal material, the lightweight metal material is about 60% of the soft steel material in terms of the width-to-thickness ratio b/t1.

As shown in FIGS. 1(a)-(c), when the anisotropic reinforcing metal plate 100 undergoes shear stress Q, the metal plate 1 is deformed such that deformation in a perpendicular direction to a surface of the metal plate 1 is restricted by the frame portion 2 and the reinforcing members 3. As a result, the rectangular region 1a of the metal plate 1 is subjected to shear yielding by shear force acting in the long side direction of the rectangular region 1a. Then, the reinforcing members 3 exert influences to the shear force in the short side direction of the rectangular region 1a of the metal plate 1, thereby adding capacity up to the large deformation range.

The numerical expression 1 given below is a balanced differential equation of an orthogonal anisotropic body flat plate on which shear force acts.

$$Numerical expression 1$$

$${D}_{x} \frac{{\partial }^{4} w}{\partial {x}^{4}} + \{ v ( {D}_{x} + {D}_{y} ) \frac{{\partial }^{2} w}{\partial {x}^{2}} \frac{{\partial }^{2} w}{\partial {y}^{2}} + {{D}_{xy} ( \frac{{\partial }^{2} w}{\partial x \partial y} )}^{2} \} + {D}_{y} \frac{{\partial }^{4} w}{\partial {y}^{4}} = 2 {N}_{xy} \frac{{\partial }^{2} w}{\partial x \partial y}$$

The first term and the third term on the left side of the numerical expression 1 are bending rigidity Dₓ, and D_{y} of a flat plate. The middle term on the left side is a sum of a Poisson ratio component of bending rigidity and torsion rigidity D_{xy}. Shear rigidity against shear force added to the flat plate is mainly the above-described torsion rigidity. Supposing that a Poisson ratio is 0.3, about 70% of the shear rigidity is dominated by the torsion rigidity, which is directly related to shear capacity.

As shown in FIGS. 1(a)-(c), in the anisotropic reinforcing metal plate 100 of the present embodiment, reinforcing members 3 are disposed in alignment at equal intervals so as to be substantially parallel. Then, the metal plate 1 is sectioned into stratified rectangular regions 1a by the frame portion 2 and the reinforcing members 3. Thereby, it is possible to increase the torsion rigidity of the metal plate 1 with respect to the torsional moment, that is, shear rigidity.

That is, at first, the metal plate 1 yields at each of the reed-shaped long rectangular regions 1a surrounded by the frame portion 2 and the reinforcing members 3 due to shear stress τ in the long side direction of the rectangular region 1a. Thereafter, the reinforcing members 3 contribute to shear stress τ in the short side direction of each rectangular region 1a, thereby maintaining the capacity up to the large deformation range.

In the anisotropic reinforcing metal plate 100 which is an orthogonal anisotropic body, plastic deformation is restricted to the rectangular regions 1a for a period of time after shear yielding. At this time, an elastic state is developed in the reinforcing members 3 placed in parallel or in the vicinity thereof. Therefore, it is possible to stabilize hysteretic characteristics of the anisotropic reinforcing metal plate 100 with respect to loads repeated on positive-negative alternation.

Therefore, the shear capacity can be maintained stably with respect to increased deformation of the anisotropic reinforcing metal plate 100 after shear yielding, without greatly increasing or decreasing shear yielding loads. Thereby, according to the anisotropic reinforcing metal plate 100 of the present embodiment, it is possible to secure dynamic stability of the metal plate 1 after shear yielding.

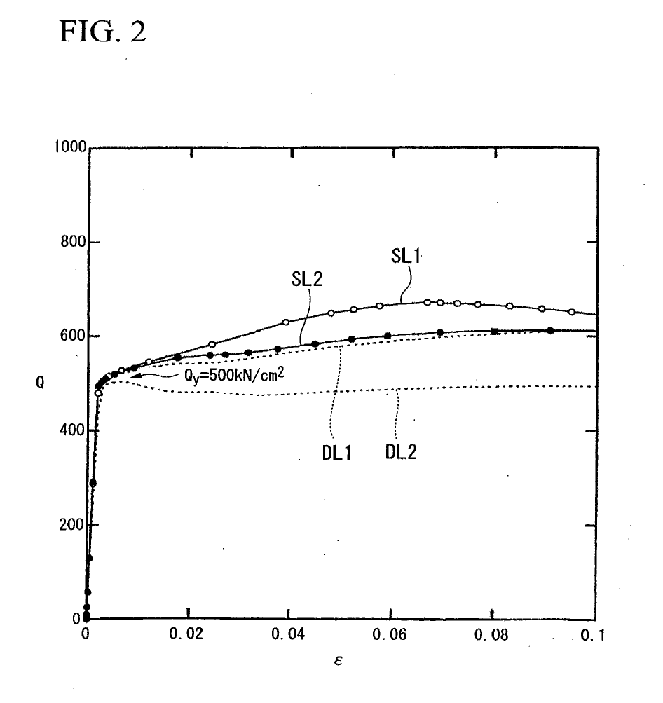

FIG. 2 is a stress strain diagram in which the vertical axis is given as shear stress Q (kN/cm²) and the horizontal axis is given as strain c. In FIG. 2, the solid line SL1 represents a stress strain diagram of the anisotropic reinforcing metal plate 100 of the present embodiment. The solid line SL2 represents a stress strain diagram where a surface of the metal plate 1 is reinforced with the reinforcing members 3 not being fixed to the metal plate 1. The dashed line DL1 represents a stress strain diagram where the metal plate 1 is provided with only the frame portion 2. The dashed line DL2 represents a stress strain diagram where only the metal frame portion 2 is provided, the width b2 of the first frame members 2a, 2b is changed to about 32 mm and the thickness t2 is changed to about 25 mm.

In FIG. 2, as shown by the solid line SL1, the anisotropic reinforcing metal plate 100 of the present embodiment is great increased in shear capacity after shear yielding. Further, the anisotropic reinforcing metal plate 100 of the present embodiment starts to reduce in capacity earlier than a case where the surface of the metal plate 1 is reinforced with the reinforcing members 3 not being fixed to the metal plate 1 as shown by the solid line SL2.

On the other hand, as shown by the dashed line DL1, where the metal plate 1 is reinforced only with the frame portion 2 and the frame portion 2 has a same dimensions as the anisotropic reinforcing metal plate 100 of the present embodiment, the reduction in capacity is prevented to some extent. However, as shown by the dashed line DL2, where the metal plate 1 is reinforced only with the frame portion 2 and the width b2 of the frame portion 2 is narrower than that of the anisotropic reinforcing metal plate 100 of the present embodiment, corner portions of the frame portion 2 are drawn to the center of the metal plate 1 to yield, by which the strength capacity is reduced immediately thereafter.

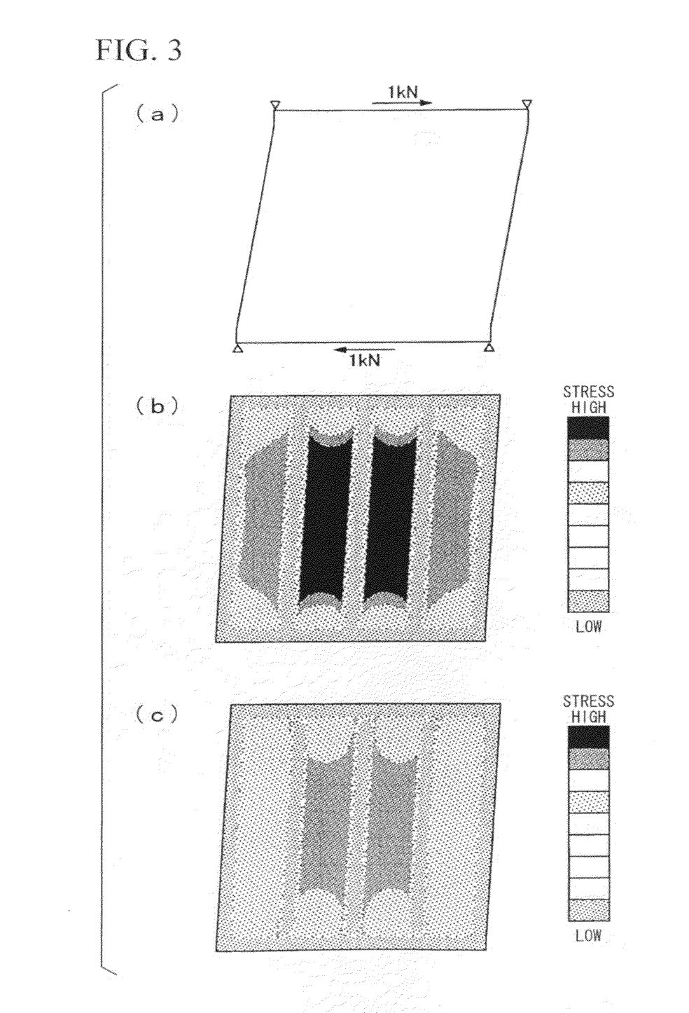

FIG. 3 are stress contour views which show shear force distribution of the metal plate 1. FIG. 3(a) shows the shear force which has been applied. FIG. 3(b) shows the shear force distribution of the metal plate 1 in an anisotropic reinforcing metal plate at which the frame portion 2 is joined to the reinforcing members 3 unlike the anisotropic reinforcing metal plate 100 of the present embodiment. FIG. 3(c) shows the shear force distribution of the metal plate 1 of the anisotropic reinforcing metal plate of the present embodiment in which the frame portion 2 is not joined to the reinforcing members 3, such that a clearance is maintained.

As shown in FIG. 3(c), where a maintained clearance is between the frame portion 2 and the reinforcing members 3, shear force is uniform as compared with the case shown in FIG. 3(b). In the case where shear force is uniformly generated, rigidity is higher and the plastic deformation also starts at the same time, by which the anisotropic reinforcing metal plate 100 is improved in yield capacity.

Therefore, according to the anisotropic reinforcing metal plate 100 of the present embodiment, the rectangular metal plate 1 on which shear force mainly acts is reinforced by the frame portion 2 and the reinforcing members 3, thus making it possible to raise torsion rigidity of the metal plate 1 and increase shear buckling loads of the metal plate 1. It is also possible to stably maintain the capacity of the anisotropic reinforcing metal plate 100 after shear yielding. Further, the metal plate 1 which is thin can be increased in plastic deformation capacity to provide a seismic resistant shear panel having hysteretic characteristics stable for loads repeated on positive-negative alternation.

As so far explained, according to the present embodiment, the anisotropic reinforcing metal plate 100 is further improved in shear capacity than a conventional anisotropic reinforcing metal plate, thus making it possible to stabilize the hysteretic characteristics (restoring force characteristics) of the anisotropic reinforcing metal plate 100.

Further, a surface of the reinforcing member 3 in a direction of the wide b3 is made to oppose the metal plate 1, by which a surface of the reinforcing member 3 in contact with the metal plate 1 can be increased in width to improve the shear rigidity.

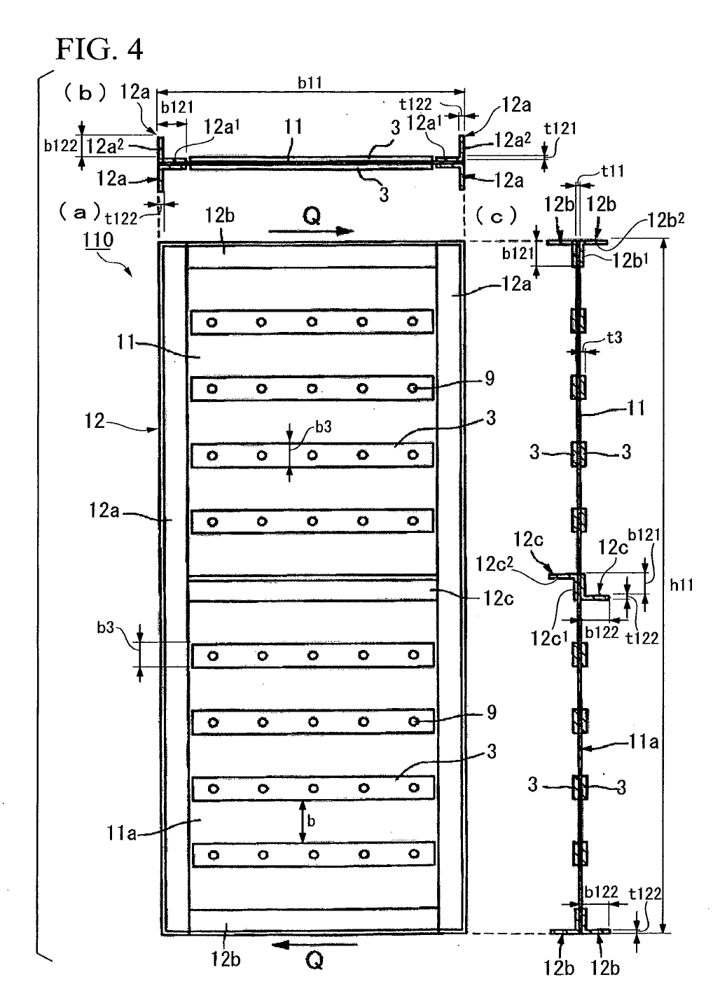

Next, an explanation will be made for a second embodiment and a third embodiment of the present invention by referring to FIGS. 4 to 6. In each of the anisotropic reinforcing metal plates related to the second embodiment and the third embodiment, in principle, a metal plate is rectangular, a frame portion or a reinforcing member is formed with L-shaped steel or channel-shaped steel and a second frame member is also provided, which is different from the above-described first embodiment. Therefore, since other portions are the same as those of the first embodiment, the same portions are given the same numeral references, and an explanation thereof is omitted.

FIG. 4 are drawings which show an anisotropic reinforcing metal plate of the second embodiment, (a) is a front elevational view, (b) is a cross sectional view, and (c) is a longitudinal sectional view.

As shown in FIG. 4, an anisotropic reinforcing metal plate 110 of the second embodiment is primarily constituted with a rectangular metal plate 11, a picture frame-like frame portion 12 and band plate-like reinforcing members 3.

The metal plate 11 is made of a metal material similar to that of the metal plate 1 of the first embodiment, for example, a rectangular metal plate with a width (width in the short side direction) b11 of about 900 mm, a height (width in the long side direction) h11 of about 2250 mm and a thickness t11 of about 3.2 mm. The anisotropic reinforcing metal plate 110 of the present embodiment adopts the metal plate 11 in which the height h11 is about two or more times greater than the width b11 and which is used, for example, as an intercolumnar-type seismic resistant panel to be placed between columns.

The frame portion 12 is installed in a picture-frame manner with a pair of first frame members 12a disposed along the first direction which is along the long side direction of the metal plate 11 and a pair of first frame members 12b disposed along the second direction which is along the short side direction of the metal plate 11. The first frame members 12a, 12b are, for example, L-shaped steel measuring 75 mm×75 mm×9 mm, and having mutually perpendicular first portions 12a1, 12b1 and mutually perpendicular second portions (second reinforcing member) 12a2, 12b2. That is, the first portions 12a1, 12b1 and the second portions 12a2, 12b2 of the first frame members 12a, 12b have rectangular cross sections in which, for example, widths b121, b122 are 75 mm, thicknesses t121, t122 are 9 mm, and the widths b121, b122 are greater than the thicknesses t121, t122. Further, the first portions 12a1, 12b1 and the second portions 12a2, 12b2 are band plate-like portions at which a direction of the width b121 and a direction of the width b122 are orthogonal to each other while directions of the length (height h11) are parallel to each other.

In the present embodiment, the first portions 12a1, 12b1 are respectively formed with the second portions 12a2, 12b2 in an integrated manner. The first frame members 12a, 12b may be formed by joining the band plate-like first portions 12a1, 12b1 to the band plate-like second portions 12a2, 12b2. Further, the first frame member 12a, 12b may be formed a T-shaped cross section or the first frame members 12a, 12b may use channel-shaped steel or C-shaped steel.

The first frame members 12a, 12b are disposed in such a manner that surfaces of the first portions 12a1, 12b1 in a direction of the width b121 oppose the metal plate 11 in substantially parallel and the first portion 12a1 is joined to the metal plate 11 by welding or using an adhesive agent. That is, the second portions 12a2, 12b2 of the first frame members 12a, 12b are fixed to the metal plate 11 via the first portions 12a1, 12b1 in such a manner that a surface in a direction of the thickness t122 opposes the metal plate 11 in substantially parallel and a surface in a direction of the width b122 is substantially perpendicular to the metal plate 11.

The first frame member 12a disposed along a long side of the metal plate 11 is joined at both end portions thereof to the end portions of the metal plate 11. The first frame member 12b disposed along a short side of the metal plate 11 is joined substantially over the entire length of the short side of the metal plate 11.

In the present embodiment, the first frame members 12a, 12b constituting the frame portion 12 are joined, for example, by welding. There is a case where between the first frame member 12a and the first frame member 12b constituting the frame portion 12 is not joined or a clearance is provided.

Approximately at the center of a long side of the metal plate 11, a second frame member 12c is placed along a short side of the metal plate 11 and substantially parallel to the short side of the metal plate 11. That is, the second frame member 12c is disposed along a second direction which is along the short side of the metal plate 11 at the center portion of the long side of the metal plate 11 in a first direction. The second frame member 12c is joined at each end portion thereof to the first frame member 12a disposed along a pair of long sides of the metal plate 11, for example, by welding and coupled to the first frame member 12a.

The second frame member 12c is L-shaped steel as with the first frame members 12a, 12b and provided with a first portion 12c1 and a second portion 12c2 as with the first frame members 12a, 12b. A surface of the first portion 12c1 in a direction of the width b121 opposes the metal plate 11 in substantially parallel. A surface of the second portion 12c2 in a direction of the width b122 is substantially perpendicular to the metal plate 11, and a surface of the second portion 12c2 in a direction of the thickness t122 opposes the metal plate 11 in substantially parallel.

The reinforcing members 3 are disposed substantially parallel to the first frame member 12b along the first frame member 12b disposed in the second direction along a short side of the rectangular frame portion 12. In the present embodiment, the frame member 3 is formed in a band plate shape with the width b3 of about 75 mm and the thickness t3 of about 12 mm, for example.

Two or more of the reinforcing members 3 are disposed in parallel at each region sectioned by the first frame members 12a, 12b and the second frame member 12c on the metal plate 11. FIG. 4 show a case where four of the reinforcing members 3 are disposed at each region. However, a greater number of the reinforcing members 3 are actually used. The number of the reinforcing members 3 is determined, for example, according to a width-to-thickness ratio Will obtained by dividing a width b of a rectangular region 11a of the metal plate 11 in the short side direction sectioned by the first frame members 12a, 12b, the second frame member 12c and the reinforcing members 3 by the thickness t11 of the metal plate 11. The width-to-thickness ratio b/t11 is determined depending on the material and the intended purpose as with the first embodiment.

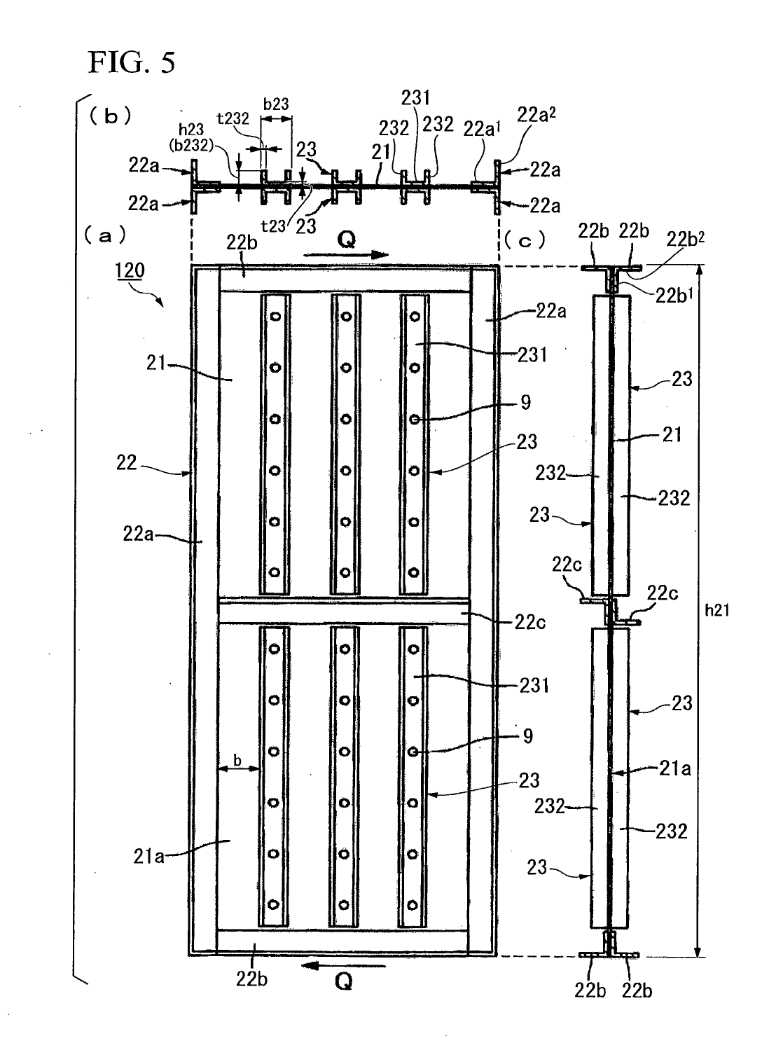

FIG. 5 are drawings which show an anisotropic reinforcing metal plate of the third embodiment, (a) is a front elevational view, (b) is a cross sectional view, and (c) is a longitudinal sectional view.

As shown in FIG. 5, an anisotropic reinforcing metal plate 120 of the present embodiment is primarily constituted with a rectangular metal plate 21, a picture frame-like frame portion 22 and reinforcing members 23 extending in one direction. The metal plate 21 is formed so as to be equal in dimensions and similar in material to the metal plate 11 of the above-described second embodiment. The frame portion 22 is constituted with a first frame member 22a and a first frame member 22b as with the frame portion 12 of the second embodiment. The first frame members 22a, 22b are provided with first portions 22a1, 22b1 and second portions 22a2, 22b2 as with the first frame members 12a, 12b of the second embodiment.

The reinforcing members 23 are formed with a material similar to the reinforcing members 3 of the first embodiment, for example, channel-shaped steel (channel) or C-shaped steel (C-shaped channel) having a first portion 231 and a second portion (second reinforcing member) 232 which are perpendicular to each other. Where the reinforcing member 23 is formed with channel-shaped steel, the steel has a width b23 of about 75 mm, a height h23 of 40 mm and a thickness t23 of about 5 mm or 7 mm, for example. Where the reinforcing member 23 is formed with C-shaped steel, the steel has the width b23 of 75 mm, the height h23 of 40 mm, the thickness t23 of 5 mm or 7 mm, with a portion extending inside a direction of the width b23 being 7 mm or 5 mm.

That is, the second portion 232 of the reinforcing member 23 has a rectangular cross section with a width b232 of 40 mm, a thickness t232 of 5 mm or 7 mm, with the width b232 being greater than the thickness t232. Further, the first portion 231 and the second portion 232 are band plate-like portions at which a direction of the width b23 is orthogonal to a direction of the width b232, with the length directions (height h21 of the metal plate 21) being parallel to each other.

In the present embodiment, the first portion 231 is formed integrated with the second portion 232. Moreover, the reinforcing member 23 may be formed by joining the band plate-like first portion 231 to the band plate-like second portion 232. Further, the reinforcing member 23 may be T-shaped in cross section, or the reinforcing member 23 may adopt L-shaped steel, the cross section of which is an L shape.

The reinforcing member 23 is disposed on both surfaces of the metal plate 21 in such a manner that a surface of the first portion 231 in a direction of the width b23 opposes the metal plate 21 in substantially parallel. The reinforcing member 23 is fixed to the metal plate 21 by fastening the first portions 231 of the pair of reinforcing members 23 by using fasteners 9 such as bolts and nuts via the metal plate 21.

Of the first frame members 22a, 22b constituting the rectangular frame portion 22, the reinforcing members 23 are disposed substantially parallel to the first frame member 22a along the first frame member 22a disposed in the first direction along a long side of the metal plate 21.

Two or more of the reinforcing members 23 are disposed in alignment substantially parallel at each of the regions sectioned by the first frame members 22a, 22b and the second frame member 22c of the metal plate 21. FIG. 5 show a case where three of the reinforcing members 23 are disposed at each region. However, a greater number of the reinforcing members 3 are actually used. The number of the reinforcing members 23 is determined, for example, according to a width-to-thickness ratio b/t21 obtained by dividing a width b of a rectangular region 21a of the metal plate 21 in the short side direction sectioned by the first frame members 22a, 22b, the second frame member 22c and the reinforcing members 23 by the thickness t21 of the metal plate 21. The width-to-thickness ratio b/t21 is determined depending on the material and the intended purpose, as with the first embodiment.

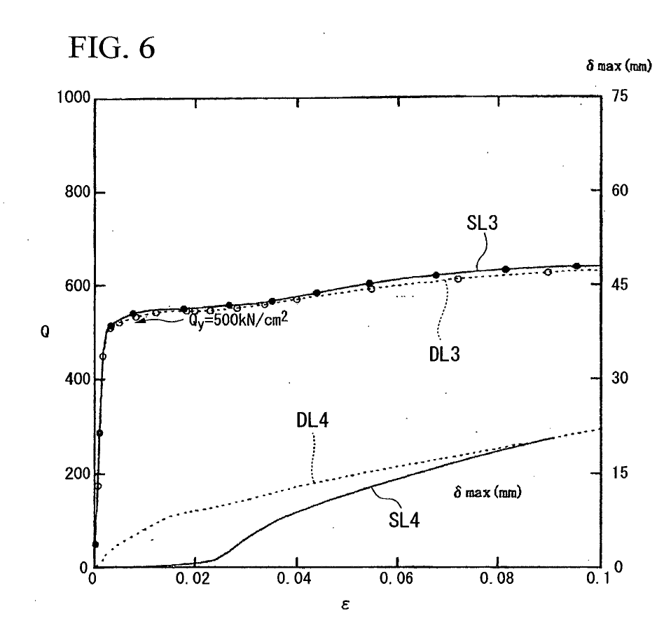

FIG. 6 is a stress strain diagram in which the vertical axis is given as shear stress Q (1N/cm²) and the horizontal axis is given as strain 8. In FIG. 6, the dashed line DL3 represents a stress strain diagram of the anisotropic reinforcing metal plate 110 of the second embodiment. The solid line SL3 represents a stress strain diagram of the anisotropic reinforcing metal plate 120 of the third embodiment. As shown in FIG. 6, both of the metal plates maintain yield shear capacity stably up to the large deformation range, indicating stable dynamic characteristics without reduction in strength capacity.

Below in FIG. 6, out-of-plane bending deformation of the metal plate 11 of the anisotropic reinforcing metal plate 110 and that of the metal plate 21 of the anisotropic reinforcing metal plate 120 are shown respectively by the dashed line DL4 and the solid line SL4. The metal plate 11 of the anisotropic reinforcing metal plate 110 indicated by the dashed line DL4 is deformed relatively great to out-of-plane from an initial stage. On the other hand, the metal plate 21 of the anisotropic reinforcing metal plate 120 indicated by the solid line SL4 is kept low in out-of-plane deformation from an initial stage.

Therefore, in order to obtain hysteretic characteristics (restoring force characteristics) as stable spindle-shaped hysteretic characteristics in relation to shear force repeated on positive-negative alternation, it is considered that the effect is great which results from the fact that the reinforcing member 23 has the second portion 232 as found in the anisotropic reinforcing metal plate 120 indicated by the solid line SL4.

The following numerical expression 2 shows relational expressions for a rectangular flat plate with a shear buckling stress degree τ_{cr}, a width b and a height h, under boundary conditions of simple support and fixed support.

$$Numerical expression 2$$

$${τ}_{cr} = \frac{{π}^{2} E}{12 ( 1 - {v}^{2} )} {( \frac{t}{b} )}^{2} \{ 4.0 {( \frac{b}{h} )}^{2} + 5.34 \} , = \frac{{π}^{2} E}{12 ( 1 - {v}^{2} )} {( \frac{t}{b} )}^{2} \{ 5.6 {( \frac{b}{h} )}^{2} + 8.98 \}$$

Inside the braces (curly brackets) of the right side of the numerical expression 2, values are given relating to bending rigidity, that is, bending torsion rigidity in association with cross sectional warping, and torsion rigidity of the flat plate. Torsion rigidity is considered predominant in the rectangular metal plate. Further, after yield of the metal plate, bending capacity decreases by enlarged buckling deformation. Therefore, the rectangular metal plate is able to obtain stable dynamic characteristics by sufficiently securing torsion rigidity, irrespective of a ratio of long side length to short side length (ratio of side length).

Here, in the rectangular metal plate 11 of the second embodiment, reinforcing members 13 are not only disposed in parallel to section the metal plate 11 into the stratified rectangular regions 11a, but the second portions 12a2, 12b2, 12c2 are also installed at the first frame members 12a, 12b and at the second frame member 12c as the second reinforcing members orthogonal to the reinforcing members 13, whenever necessary.

Further, in the rectangular metal plate 21 of the third embodiment, not only are a plurality of reinforcing members 23 disposed in alignment to section the metal plate 21 into stratified rectangular regions 21a but also the second portions 22a2, 22b2 of the first frame members 22a, 22b and the second portions 232 of the reinforcing members 23 are installed as the second reinforcing member orthogonal to the first portions 231 of the reinforcing members 23, whenever necessary.

It is, thereby, possible to sufficiently secure torsion rigidity by reinforcing the metal plates 11, 21 and also to form a truss-like force balance and diagonal tensile force enlarged and grown after yield with respect to great shear deformation. In other words, it is possible to give stable dynamic characteristics to the anisotropic reinforcing metal plates 110, 120 at the large deformation range after shear yielding by maintaining a balanced force. That is, the anisotropic reinforcing metal plates 110, 120 are able to secure shear capacity without greatly changing the disposition of the reinforcing members 3, 23.

The present invention shall not be limited to the above-described embodiments and can be carried out in various modifications within a scope not departing from the gist of the present invention. For example, in the second embodiment and the third embodiment, an explanation has been made for a case where the first frame member and the second frame member are provided with the first portions and the second portions. However, the first frame member or the second frame member may not have the second portions. That is, in the above-described second embodiment and the third embodiment, the first frame member and the second frame member may be flat steel having a rectangular cross section which are free of the second portions. Also in the third embodiment, the reinforcing member may be flat steel having a rectangular cross section which is free of the second portions.

Further, in the above-described second embodiment and the third embodiment, an explanation has been made for a case where the metal plate is held between the reinforcing members on both surfaces to fasten the reinforcing members by using fasteners, thereby fixing the reinforcing members to the metal plate. However, a method for fixing the reinforcing members to the metal plate is not limited thereto and, for example, the reinforcing members may be joined by welding or using an adhesive agent to one surface or both surfaces of the metal plate in a spot pattern, a linear pattern or an areal pattern, thereby forming the reinforcing members integrated with the metal plate.

Each of the above-described embodiments deals with a reinforcing structure in which the metal plate on which in-plane shear force acts is reinforced so as to have orthogonal anisotropic properties. The structure is relatively simple, easy to manufacture and high in utility. In intercolumnar-type shear panels and wall-type shear panels having a large metal plate surface, a conventional reinforcing structure in which square metal plates are reinforced in a lattice form is increased in the number of members, which is disadvantageous. On the other hand, in the present invention, an anisotropic reinforcing structure is provided, thus making it possible to simplify the structure as a whole and easily utilize various types of metal materials as a metal plate on which shear force acts.

Further, as described in each of the above embodiments, the metal plate is held between the reinforcing members on both surfaces thereof and fixed by using fasteners. Thus, a thinner metal plate is usable, thereby giving a greater possibility of making a seismic resistant shear panel lighter in weight and lower in price.

A further, in the above-described present embodiments, joining in a spot pattern includes spot welding and joining with bolts, for example. Joining in a linear pattern includes fillet welding and butt welding, and joining in an areal pattern includes joining with an adhesive agent.

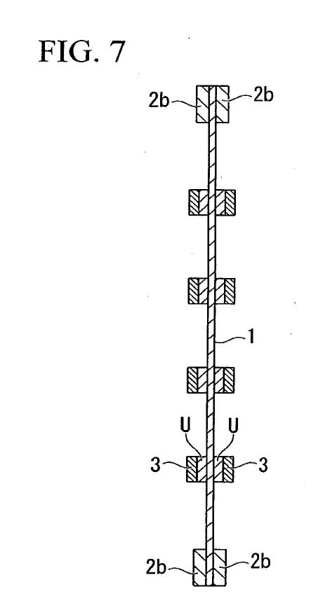

In addition, as shown in FIG. 7, in all the embodiments so far described, an unbonded material U may be coated or pasted between the metal plate 1 and the reinforcing member 3. When the unbonded material U capable of reducing frictional force is placed between the members, the metal plate 1 is made more uniform in shear stress to keep the restoring force stable, thereby improving resistance to low-cycle fatigue.

### INDUSTRIAL APPLICABILITY

The present invention relates to an anisotropic reinforcing metal plate and is usable, for example, as a seismic resistant member or a damping member to be used in buildings and other structures.

### DESCRIPTION OF REFERENCE NUMERALS

1, 11, 21: metal plate, 1a, 11a, 21a: rectangular region, 2a, 2b, 12a, 12b, 22a, 22b: first frame member, 12a2, 12b2, 22a2, 22b2: second portion (second reinforcing member), 12c, 22c: second frame member, 3, 23: reinforcing member, 232: second portion (second reinforcing member), 100, 110, 120: anisotropic reinforcing metal plate, b2, b3, b23, b121, b122, b232: width, b/t1, b/t11, b/t21: width-to-thickness ratio, t3, t23, t122, t232: thickness, U: unbonded material

1. An anisotropic reinforcing metal plate having a high shear capacity in a predetermined direction,
the anisotropic reinforcing metal plate, comprising:
a rectangular metal plate;
a first frame member disposed along a first direction and a second direction along an external edge of the metal plate and fixed to the metal plate in such a manner that a surface along the width direction opposes the metal plate; and
reinforcing members disposed along the first direction or the second direction.

2. The anisotropic reinforcing metal plate according to claim 1, wherein
the reinforcing member is fixed to the metal plate so that a surface along the width direction opposes the metal plate.

3. The anisotropic reinforcing metal plate according to claim 1, wherein
the anisotropic reinforcing metal plate has a clearance between the first frame member and the reinforcing member.

4. The anisotropic reinforcing metal plate according to claim 1, wherein
the metal plate is longer in the first direction than in the second direction, and
the anisotropic reinforcing metal plate which is further provided with a second frame member disposed along the second direction at the center portion of the metal plate in the first direction with the reinforcing member is disposed between the first frame member and the second frame member disposed along the second direction.

5. The anisotropic reinforcing metal plate according to claim 1 which is further provided with an unbonded material between the metal plate and the reinforcing member.

6. The anisotropic reinforcing metal plate according to claim 2, wherein
the anisotropic reinforcing metal plate has a clearance between the first frame member and the reinforcing member.

7. The anisotropic reinforcing metal plate according to claim 2, wherein
the metal plate is longer in the first direction than in the second direction, and
the anisotropic reinforcing metal plate which is further provided with a second frame member disposed along the second direction at the center portion of the metal plate in the first direction with the reinforcing member is disposed between the first frame member and the second frame member disposed along the second direction.

8. The anisotropic reinforcing metal plate according to claim 2 which is further provided with an unbonded material between the metal plate and the reinforcing member.
